(19) United States
(12) Patent Application Publication
(10) Pub. No.: US 2013/0012149 A1
(43) Pub. Date: Jan. 10, 2013

(54) Adaptive Real-time Control System for Transceiver Level and Gain Regulation

(75) Inventors: Slim Ben Ghalba, Ottawa (CA); Mihai Parvan, Gloucester (CA); Peter Zahariev Rashev, Calgary (CA)

(73) Assignee: TELEFONAKTIEBOLAGET L M ERICSSON (PUBL), Stockholm (SE)

(21) Appl. No.: 13/177,175

(22) Filed: Jul. 6, 2011

(51) Int. Cl. H04B 17/00; H04B 1/06

(52) U.S. Cl. 455/226.1; 455/232.1

(57) ABSTRACT

Adaptive gain regulation is performed by measuring one or more real-time closed-loop statistics for a signal output from a gain-controllable circuit and blindly adjusting the gain of the gain-controllable circuit based on the one or more real-time closed-loop statistics measured for the signal so that the signal output by the gain-controllable circuit satisfies a predetermined criteria without using a priori information about the signal.

### TECHNICAL FIELD

The present application relates to transceiver level and gain regulation, in particular an adaptive real-time control system for transceiver level and gain regulation.

### BACKGROUND

Transmitter and receiver gain control for the purpose of maintaining input-output signal relationships can be implemented by adaptively controlling mixed analog and digital regulators to be used in various transceiver applications. In some cases the signals being controlled can be of unknown nature such as receiver signals or known signals such as in the transmitter. Algorithms which depend on signal power metrics such as mean, peak, histogram, etc. are commonly used in transceiver applications. The power data are averaged further, compared and eventually mapped against a table of pre-set thresholds in deciding whether to decrease or increase the gain-regulation elements in the receiver and/or transmitter data paths. Such conventional approaches utilize finite state-machines which move between different system states in a tabulated, pre-determined trajectory using a pre-calculated number of discrete transitions.

These conventional approaches are based on certain assumptions about the signal statistics which complicate the gain control algorithm, and force the threshold tables and state transitions to be dependent on a signal profile (i.e. use-case) often having behavior which is difficult to model or even predict. Also the use of hard-coded gain control values in response to signal statistics leads to overestimation or underestimation of the gain value required to regulate a certain transceiver signal, yielding a non-optimal solution. Such conventional approaches also rely on calibration and characterization of the transfer function of the gain-regulation elements in order to achieve predictable transitions between gain values for each state. Extra effort is needed to define a comprehensive set of gain change trajectories and control scenarios which yield an optimal solution, while strongly depending on signal morphology and use-cases.

### SUMMARY

Embodiments described herein provide adaptive gain control of smoothly-controlled digital and step-wise controlled analog regulators without having to calibrate or characterize the analog regulators. Instead, real-time closed-loop derivation of parameters for setting the gain to an optimal value in response to arbitrary transceiver signal statistics is employed. The adaptive real-time control system measures stimulus-response in a real-time manner without a priori knowledge of the nature of the signal.

Convergence to an optimal system state is realized by using fast successive iterations leading to a solution which maintains an arbitrary signal profile by tracking a signal of certain signal properties (e.g. peak or mean power) and/or a ratio of two signals (e.g. input-output relationship) based on RF gain regulation. The derived control parameters are used to change digital and step-wise analog regulators with dead zones such as RF attenuators and can handle unknown non-linearities in their transfer functions.

The adaptive real-time approach described herein derives optimal gain values when exposed to the same type of signal by accurately estimating the parameters, which would otherwise require the use of predefined values from calibration or characterization tables. The gain estimation can be based on least-mean square algorithm that does not require a priori information about disturbance of the controlled state and uses closed-loop control to quickly stabilize the controlled parameters.

According to an embodiment of a method of adaptive gain regulation, the method includes measuring one or more real-time closed-loop statistics for a signal output from a gain-controllable circuit and blindly adjusting the gain of the gain-controllable circuit based on the one or more real-time closed-loop statistics measured for the signal so that the signal output by the gain-controllable circuit satisfies a predetermined criteria without using a priori information about the signal.

According to an embodiment of an adaptive gain controller, the adaptive gain controller includes a gain-controllable circuit, an estimator and a closed-loop control system. The estimator is operable to measure one or more real-time statistics for a signal output from the gain-controllable circuit. The closed-loop control system is operable to blindly adjust the gain of the gain-controllable circuit based on the one or more real-time statistics measured for the signal so that the signal output by the gain-controllable circuit satisfies a predetermined criteria without using a priori information about the signal.

Those skilled in the art will recognize additional features and advantages upon reading the following detailed description, and upon viewing the accompanying drawings.

### BRIEF DESCRIPTION OF THE FIGURES

The elements of the drawings are not necessarily to scale relative to each other. Like reference numerals designate corresponding similar parts. The features of the various illustrated embodiments can be combined unless they exclude each other. Embodiments are depicted in the drawings and are detailed in the description which follows.

FIG. 1 illustrates a block diagram of adaptive gain controller.

FIG. 2 illustrates an adaptive gain controller using a least means square (LMS) control loop.

FIG. 3 illustrates an adaptive gain controller and a digital regulator in a receiver chain.

FIG. 4 illustrates a block diagram of a state machine included in an adaptive gain controller.

FIG. 5 illustrates a block diagram of a transmitter which includes an adaptive gain controller.

FIG. 6 illustrates a block diagram of another transmitter which includes an adaptive gain controller.

FIG. 7 illustrates a block diagram of a transceiver which includes an adaptive gain controller.

### DETAILED DESCRIPTION

Various embodiments are described herein which relate to an adaptive gain controller. The adaptive gain controller can be used in receivers, transmitters and transceivers. The adaptive gain controller includes a gain-controllable circuit, an estimator and a closed-loop control system. The estimator measures one or more real-time statistics for a signal output from the gain-controllable circuit. The closed-loop control system blindly adjusts the gain of the gain-controllable circuit based on the one or more real-time statistics measured for the signal so that the signal output by the gain-controllable circuit satisfies a predetermined criteria without using a priori information about the signal. As such, predefined values from calibration or characterization tables are not used in setting the gain. The transmitter and receiver systems described below can be interchanged in that they are applicable to either transmit or receive scenarios after minor adjustments to the interface connections. The embodiments described herein are representative of a 4G radio system implementation (e.g. remote radio unit, or RRUL) where signal level regulation is required in the downlink and blind gain regulation is required in the uplink. Other systems such as relay stations, etc. may require these functions to be present in both down and uplink directions.

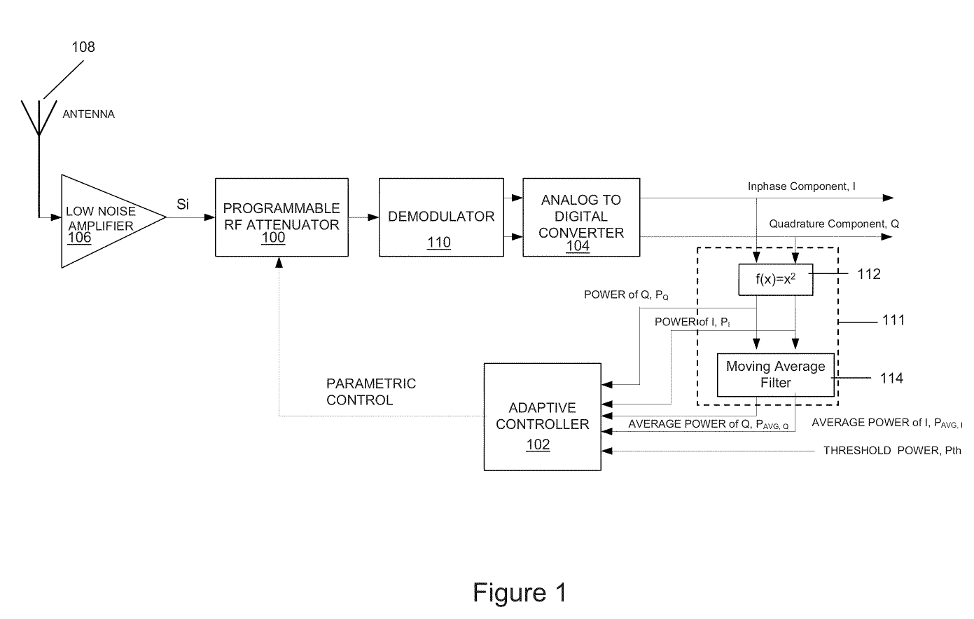

FIG. 1 illustrates an embodiment of the adaptive gain controller. According to this embodiment, the adaptive gain controller is included in a receiver. The gain-controllable circuit is a programmable RF attenuator 100, the gain of which is adjusted by an adaptive controller 102. The gain adjustment is implemented coarsely first, and then finely. To be activated, the adaptive controller 102 receives an overflow signal (OVR) from an A/D (analog-to-digital) converter 104. The OVR signal goes high when the ND converter 104 clips the input signal (Si) which is provided to the programmable RF attenuator 100 from a low noise amplifier 106. When the signal level is high at the antenna 108 and the gain is constant, the signal level of Si can exceed the full-scale (FS) of the ND converter 104 and thus clipping occurs. Upon activation in response to the OVR signal, the adaptive controller 102 coarsely adjusts the gain of the programmable RF attenuator 100 to a predefined value in order to reduce the gain. The coarse adjustment process implemented by the adaptive controller 102 brings the signal level at the A/D converter 104 below FS of the A/D converter 104 to stop the signal clipping.

The adaptive controller 102 then implements a fine gain adjustment process to optimally tune the gain of the programmable RF attenuator 100. Once the signal level is below FS of the ND converter 104, the adaptive controller 102 computes the optimal gain that brings the average power (P_{AVG,Q} and P_{AVG,I}) at the output of the A/D converter 104 to a predefined threshold (P_{Th}). The adaptive controller 102 ensures that the gain is accurate regardless of the power level at the antenna port 108, without using a priori information about the signal. In one embodiment, the adaptive controller 102 performs the gain computation using the instantaneous power of in-phase (I) and quadrature (Q) components of the signal, as provided by a demodulator 110. To this end, the estimator 111 includes a power computing circuit 112 which computes the instantaneous powers (P_{I}) and (P_{Q}) of the in-phase (I) and quadrature (Q) signals, respectively. The estimator 111 can also include a moving average filter 114 which calculates the average power P_{AVG} of the signal at the output of the ND converter 104 as given by P_{AVG}=Max(P_{AVG,Q}, P_{AVG,I}). The adaptive controller 102 can also use P_{I}/P_{Q} and/or P_{AVG} to adjust the gain as described in more detail later herein.

In one embodiment, the adaptive controller 102 implements a step-size mixed analog-digital LMS (least means square) control loop where the optimal gain of the receiver is computed so that the interference is prevented from clipping the signal at the A/D converter 104. The computation of the optimal gain is performed by comparing the maximum of the instantaneous powers (P_{I}) and (P_{Q}) to the threshold P_{Th}.

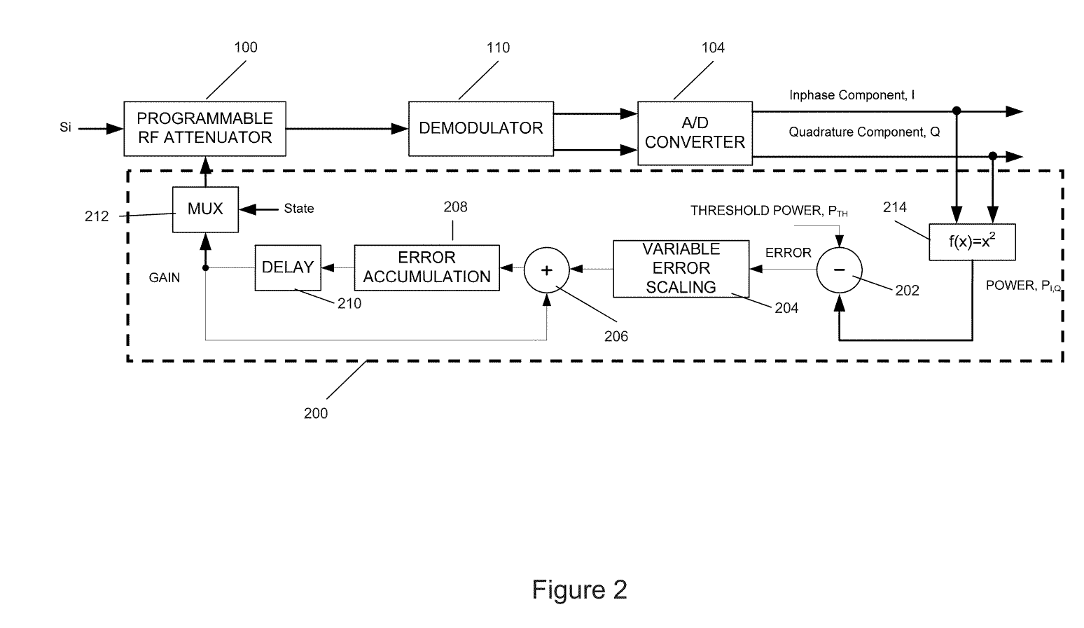

FIG. 2 illustrates an embodiment of the LMS control loop 200 implemented by the adaptive controller 102. According to this embodiment, the LMS control loop 200 includes a subtractor 202, a variable error scaler 204, a summer 206, an error accumulator 208, a delay block 210, a multiplexer 212 and a signal squarer 214. The input signal Si is a complex signal as given by Si=I+j*Q. The power computing circuit 112 computes the instantaneous powers (P_{Q}) and (P_{I}) of the quadrature (Q) and in-phase (I) signal components, respectively, as given by P_{Q}=Q² and P_{I}=I². The power computing circuit 112 also computes the instantaneous power statistic P_{I,Q} used to compute the gain as given by P=Max(P_{Q}, P_{I}). The subtractor 202 computes the error[n] of the LMS control loop 200 as given by error[n]=P_{Th}−gain[n−1]*P[n−1]. The variable error scaler 204, summer 206, error accumulator 208, and delay block 210 compute the gain input to the programmable RF attenuator 100 as given by Gain[n]=μ*Error[n]+Gain[n−1]. The LMS control loop 200 implemented by the adaptive controller 102 minimizes the error[n] to zero. At convergence, error[n]=0 and Gain[n]=Gain[n−1]. The variable scaler μ controls the speed of convergence of the LMS control loop 200. The value of Gain[n] is continuously assigned to the programmable RF attenuator 100, which in one embodiment has a 1 dB step.

Many receivers require the gain to remain constant. However, the LMS control loop 200 implemented by the adaptive controller 102 changes the gain according to the level of the interferer. In order to compensate for the gain changes in the analog realm, a digital equalization process can be provided which ensures the overall receiver gain is constant at all times.

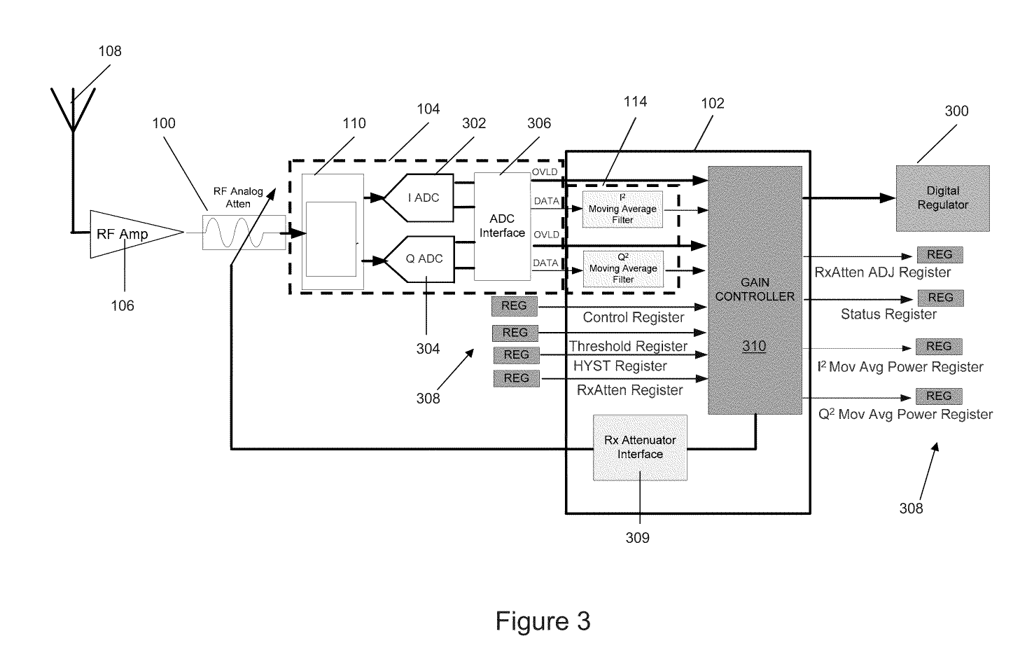

FIG. 3 illustrates an embodiment of a receiver which includes the adaptive controller 102 and a digital regulator 300. FIG. 3 also shows the A/D converter 104 in more detail. The A/D converter 104 includes an A/D block 302 for the in-phase signal component (I) and another A/D block 304 for the quadrature-phase signal component (Q). The ND converter 104 further includes an ND interface 306 which provides the overflow signal (OVR) and data for both I and Q signal components to the adaptive controller 102. The adaptive controller 102 receives other inputs from registers 308 such as control information, the predefined threshold (P_{Th}), hysteresis information (HYST), and receiver attenuation information (RxAtten). The adaptive controller 102 provides the gain value to the programmable RF attenuator 100 via a receiver attenuator interface 309. The adaptive controller 102 includes a state machine 310 for implementing the LMS control loop to adjust the gain according to the level of the interferer. The state machine 310 can also program the digital regulator 300 with a negative gain that was applied to the analog attenuator 100 after a predefined delay representing the response time of the analog attenuator 100 to compensate for the gain changes in the analog realm so that the overall receiver gain is constant at all times.

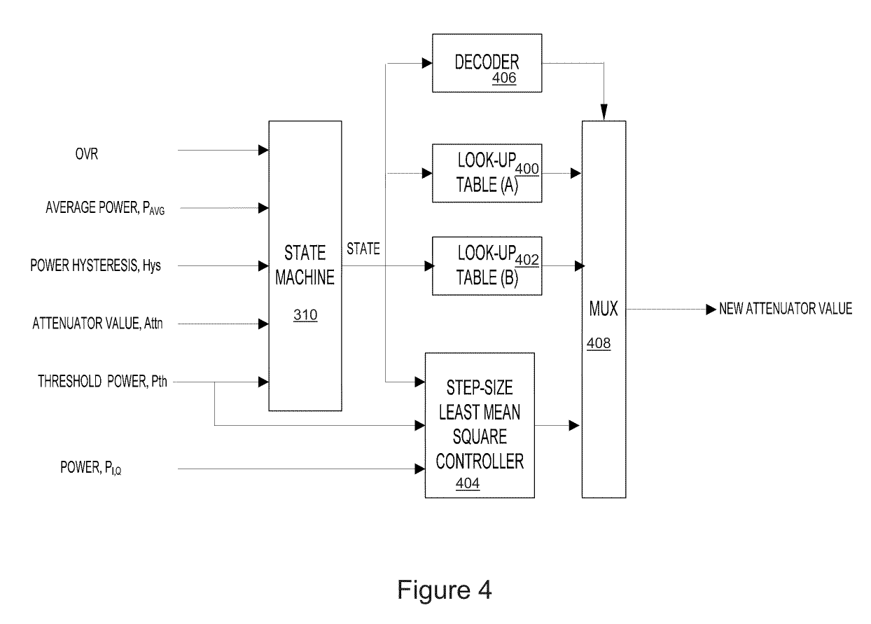

FIG. 4 illustrates an embodiment of the state machine 310 included in the adaptive controller 102. According to this embodiment, the state machine 310 implements receiver blind gain regulation by coordinating the actions of the open-loop control system according to the fluctuations in the RF environment. The state machine 310 has five event driven states. The transition from one state to another depends on measurements of three parameters: instantaneous power, average power at the output of the ND converter 104 and current gain of the receiver. The state machine 310 has one output: the new attenuator value (gain) assigned to the programmable RF attenuator 100. The optimal gain determined for the attenuator 100 is obtained either from a first look-up table (LUT) 400, a second look-up table (LUT) 402 or the step-size LMS loop implemented by a step-size LMS controller 404 as described above, depending on the state. The contents of the first look-up table 400 can be linearly increasing gain values, in dB units, typically of step size equal to the resolution of the programmable RF attenuator 100. The second look-up table 402 can store values which implement a steep gain decrease function and therefore exponential function such as 2̂n can be applicable. The look-up tables 400, 402 specify gain control profiles represented respectively by arithmetic and geometric series of iterative change.

There are five inputs to the state machine 310: OVR (the overflow signal from the A/D converter 104); P_{AVG}=Max(P_{AVG,Q}, P_{AVG,I}) (the average power of the signal at the output of the A/D converter 104 calculated by the moving average filter 114); P_{TH} (the target threshold power for the signal at the output of the A/D converter 104); Hyst (the hysteresis allowed for the signal to vary); and Attn (the current value of the attenuator 100). A decoder 406 determines which gain value is provided to the programmable RF attenuator 100 via a multiplexer 408, depending on the state. Table 1 below lists the response of the state machine 310 to RF environment fluctuations.

TABLE 1
Finite State Machine States

| RF | | | |
|---|---|---|---|
| Environment | A/D Converter | State | Action Taken |
| No | OVR = 0, P < FS | IDLE | No action, gain is at nominal value |
| interference | | | |
| Interference | OVR = 1, P > FS | DECRGAIN | Decrease gain based on values from LUT |
| on | | | (A) to stop clipping of signal |
| Interference | OVR = 0, P < FS, | SETGAIN | Set optimal gain using Step-size LMS |
| on | | | Loop controller to bring P_{AVG} as close as |
| | | | possible to P_{Th} |
| Interference | OVR = 0 | FRZGAIN | Freeze gain and allow average power to |
| on | P_{Th} − Hyst < P_{AVG} < | | fluctuate within +/− Hyst |
| | P_{Th} + Hyst | | |
| Interference | OVR = 0; P_{AVG} >= P_{Th} + | SETGAIN | decrease gain to accommodate increase |
| level increased | Hyst | | in interference level beyond +/− Hyst |
| Interference | OVR = 0; P_{AVG} <= P_{Th} − | ADJGAIN | increase gain to accommodate decrease |
| level | Hyst | | in interference level beyond +/− Hyst |
| decreased | | | |
| Interference | OVR = 0 | INCRGAIN | Increase gain based on values from |
| disappeared | | | LUT(B) until nominal gain is reached |

Coarse gain adjustments are made to the programmable RF attenuator via the first look-up table 400 when clipping occurs. The second look-up table 402 is used to return the gain to a nominal value after the interference subsides. The step-size LMS controller 404 implements step-size LMS loop control as described previously herein and as indicated in Table 1 to adjust the gain. For example, the step-size LMS controller 404 can finely adjust (increase or decrease) the gain to bring the average power P_{AVG} as close as possible to the predetermined power threshold criteria P_{TH}, or can freeze the gain so that P_{AVG} fluctuates within acceptable margins (hysteresis). A subsequent increase or decrease in the interference level results in a corresponding adjustment of the gain. This way, the adaptive controller 102 provides both coarse and fine gain adjustment without having to calibrate or characterize the programmable RF attenuator 100 and without a priori information about the signal of interest. That is, the adaptive controller 102 reacts to various RF fluctuations with a combination of coarse and fine gain adjustments which allow the closed-loop control system to react fast to an interferer (including pulsed interferers) while accurately computing the optimal gain adjustment required to combat the interference.

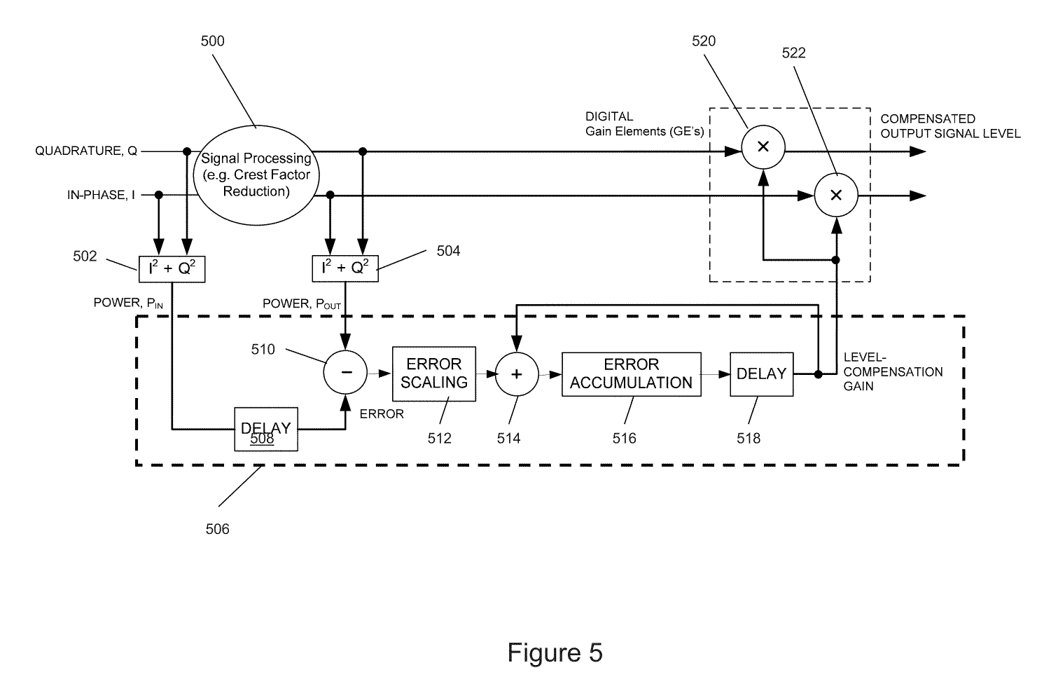

FIG. 5 illustrates another embodiment of the adaptive gain controller. According to this embodiment, the adaptive gain controller is included in a transmitter and provides signal level tracking. The transmitter includes a signal processing circuit 500 such as a crest-factor reduction circuit, a digital predistortion circuit, an adaptive frequency response/pulse shaping circuit, etc. which implements dynamic signal change which is unknown in advance. Crest factor reduction (CFR) is a technique widely used in LTE (long term evolution) systems. Once a signal passes through a CFR block, its average power is reduced compared to the original power of the signal. The adaptive gain controller described herein can be used to regulate the power of the signal going through the CFR block. That is, the adaptive gain controller functions as a signal tracking circuit which equalizes the powers of the input and output signals before and after the CFR block.

As shown in FIG. 5, the adaptive gain controller includes a first power estimator 502 which calculates the instantaneous power (P_{IN}) of the signal before the CFR block and a second power estimator 504 which calculates the instantaneous power (P_{OUT}) of the signal after the CFR block. The power estimators 502, 504 are connected to a least-mean square loop 506. The loop 506 includes a first delay block 508, a subtractor 510, an error scaler 512, a summer 514, an error accumulator 516 and a second delay block 518. The loop 506 tracks the variation of P_{IN} and adjusts the digital scaling (multiplier) such that the average of the power after multipliers 520, 522 is equal to the average of P_{IN}. The loop 506 is very fast and reacts on a sample-by-sample basis. During operation of the CFR block, the peak-to-peak variation of the power level is not changed due to the intended effects of the peak sample power reduction. By properly choosing the error scaling factor, the effect of the level compensation gain is limited to removing the slower changing mean value of the power difference without negating the effects of the faster crest factor reduction related signal changes.

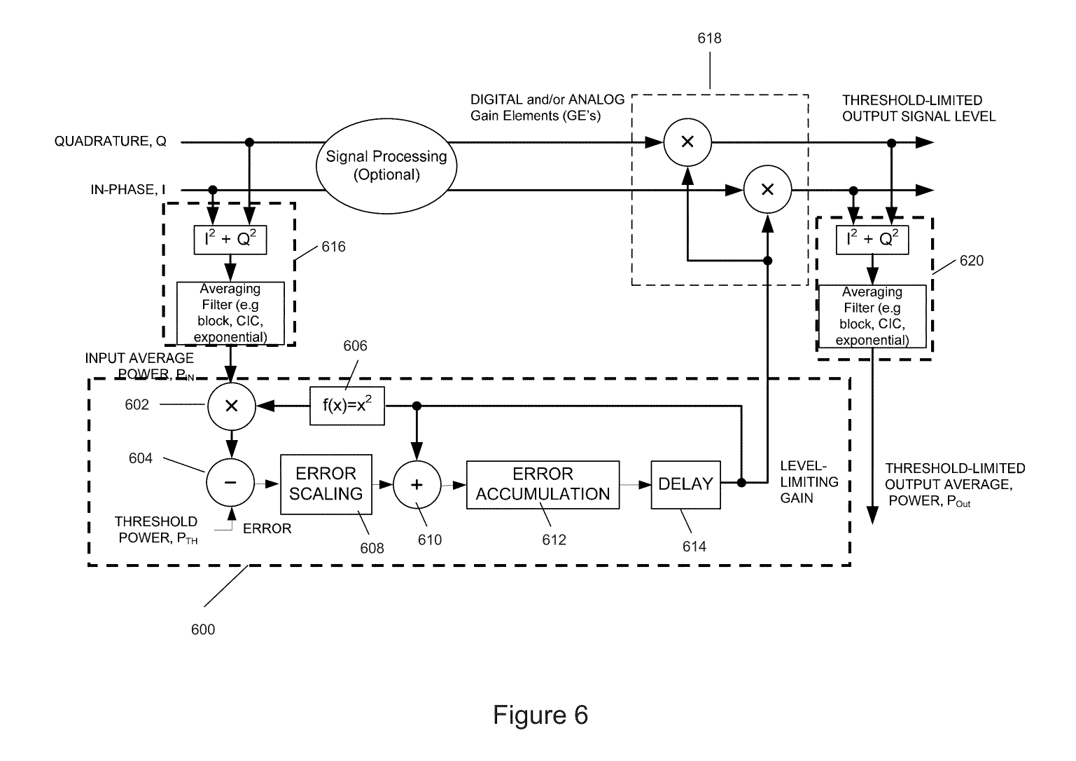

FIG. 6 illustrates an embodiment of the adaptive gain controller included in a transmitter for providing overpower protection. The adaptive gain controller maintains the average power below a certain threshold according to this embodiment. As shown in FIG. 6, an LMS loop 600 uses average power instead of instantaneous powers as shown in FIG. 5. The reaction of the LMS loop 600 is relatively slow and allows for overpower protection. The LMS loop 600 includes a multiplier 602, a subtractor 604, a signal squarer 606, a summer 610, an error accumulator 612 and a delay block 614. The LMS loop 600 adjusts the digital scaling (multiplier) such that P_{OUT}<=P_{TH}. To this end, the power is averaged using a long average Cascaded-Integrator Comb (CIC) filter 616 with a time constant e.g. in the order of milliseconds. The output P_{IN} of the CIC filter 616 is compared against a predetermined threshold P_{TH} and the ratio is calculated according to following equations: error[n]=P_{TH}−P_{IN}[n−1]*Gain[n−1]2; and Gain[n]=μ*Error[n−1]+Gain[n−1], where Gain is the level-limiting gain applied to the digital and/or analog gain element(s) 618. The LMS loop 600 minimizes Error[n] to zero. At convergence, Error[n]=0 and Gain[n]=Gain[n−1]=Sqrt(P_{TH}/P_{IN}).

Multiplying the in-phase (I) and quadrature (Q) signal components by Gain ensures that P_{OUT} is always less than or equal to P_{TH}. In this way, if there is an overpower condition, the power is regulated to be less than or equal to the predefined threshold. Either a digital regulator or an analog attenuator can be used. Input and output power averaging filters 616, 620 are used according to an embodiment with zero overlap. The latency of the reaction is matched to the size of power level averaging. Faster absolute response times require less power averaging. The signal level is brought within the specified window around the set threshold after one block averaging period. The recovery from a high power level is not impacted as the threshold-limited and input signals reach steady state at the same time (measured in averaging periods). Better dynamic performance can be achieved if exponential moving average filters are used where the latency of the average power measurement is much smaller (the overlap can be as large as N-1 samples, where N is the number averaged instantaneous power samples).

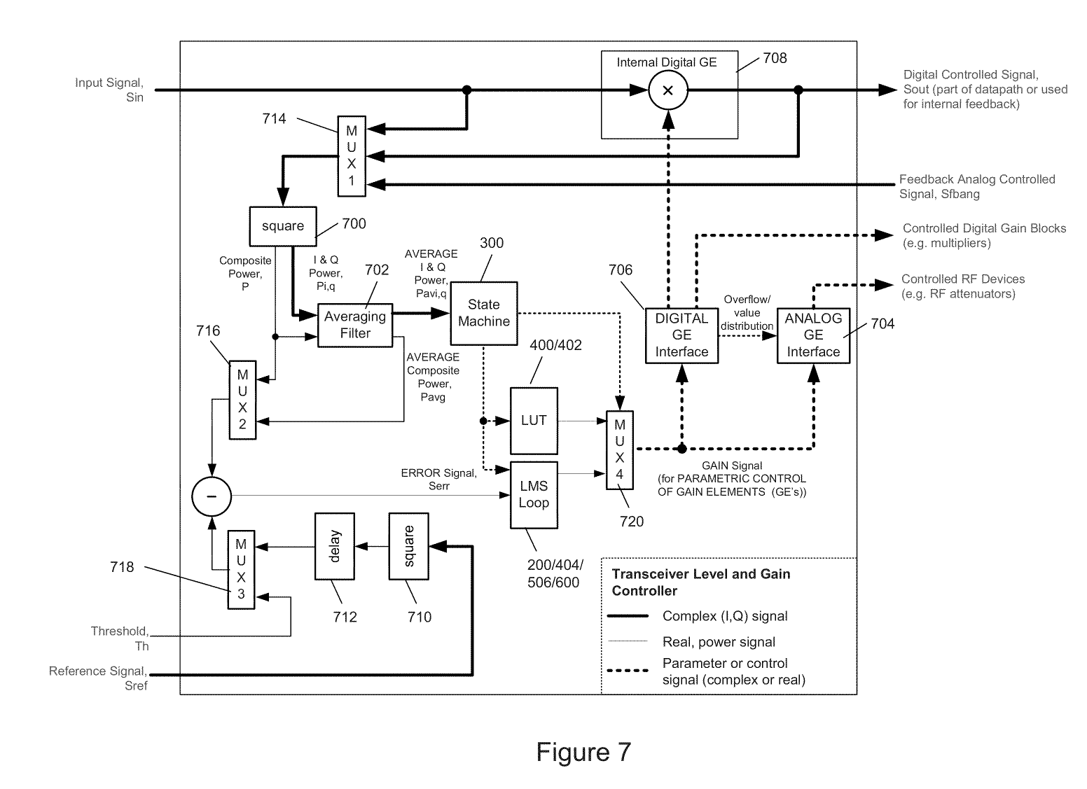

FIG. 7 illustrates yet another embodiment of the adaptive gain controller. According to this embodiment, the adaptive gain controller is included in a transceiver and provides level and gain control. The input to the circuit is a complex signal Sin and the output of the circuit is a complex regulated signal Sout. The power P of the input signal is obtained by squaring Sin via a signal squarer 700. The average power Pavg is obtained by passing the power P through an averaging filter 702. The filter 702 can be CIC, exponential or block averaging. The signal Sfbang represents a digitized feedback signal which has been properly downconverted and/or demodulated from the output of an RF analog attenuator (not shown in FIG. 7) in the transceiver data paths. The control interface of such an attenuator is connected to an analog gain element interface block 704.

Digital gain element(s) (also not shown in FIG. 7) in the data paths can likewise be connected to a digital gain element interface block 706 in addition to an internal digital gain element(s) 708 which itself may or may not be part of a data path. The interface blocks 704, 706 are responsible for proper partitioning of the digital and analog gain element values so that requirements for optimal dynamic range are followed as per radio system specifications. The target level used to construct the error signal (Serr) can be a constant set by the user, a predetermined threshold criteria Th, or a time varying signal, Sref, such as a transmitter or receiver data path signal, which can be squared by a squaring circuit 710 and delayed by a delay element 712. The signal examples mentioned above can be implemented by selecting a certain combination of positions of multiplexers 714, 716, 718, 720 as shown in Table 2 below to realize certain applications such as signal level tracking, overpower protection and gain regulation, e.g. as previously described herein.

TABLE 2
Possible Applications and Configuration Modes

| | MUX position | | | |
|---|---|---|---|---|
| Application | MUX 1 | MUX 2 | MUX 3 | MUX 4 |
| Signal level tracking | Sin | P | Sref | LMS Loop |
| Overpower protection | Sout | Pavg | Th | LMS Loop |
| Receiver overpower | Sfbang | P | Th | State Machine |
| protection | | | | controlled |
| Transmitter gain | Sfbang | P | Sref | LMS Loop or State |
| regulation | | | | Machine controlled |

The universal transceiver level and gain controller shown in FIG. 7 can accurately compute the regulation value required to keep the level of the signal with respect to a given constant threshold, accurately compute the regulation value required to keep the level of the signal with respect to a time-varying reference signal, achieve convergence with a digital regulator based control system, achieve convergence with a step-wise analog regulator based closed-loop control system, accurately regulate signal levels of known or unknown type of nature, work in an analog, digital or mixed-analog digital environment, and work in the transmitter path and/or receiver path.

Moreover, the closed-loop control system described herein utilizes a generic methodology applicable to any transceiver gain or signal-level regulation problem utilizing the universal principles of closed-loop and adaptive control. The described embodiments are multifunctional and robust with respect to use-cases of signals from 2G, 3G and 4G air-interfaces, and retain their implementation simplicity while being sufficiently flexible to meet diverse design goals. Functionally, each embodiment can be realized by configuring a real-time computational circuit. The basic mathematical functions underlining the behavior of the real-time computational circuit are common while the inputs change per system application. By providing a set of configurable inputs and re-using the same number-processing, a universal controller can be defined.

A radio transceiver system utilizing the described universal controller can provide signal level regulation without any need for calibration accept e.g. as derived from minimization of an error function. The radio transceiver can also implement gain regulation without any need for complex configurations and/or calibration except e.g. as derived from minimization of an error function, use a simple behavioral state machine for controlling variations in the RF environment which otherwise require a very complex (heuristic) algorithm, compensate non-linearity and resolution limitations of RF regulators, and provide a generic solution to data path gain and level regulation problems and scenarios encountered in base station transceivers.

The proposed controller is organized as one multi-purpose functional block which can be shared or instantiated several times to increase performance/throughput. It can be realized as a stand-alone programmable or re-configurable core in ASIC (application-specific integrated-circuit) or FPGA (field programmable gate array) or as a generic microprocessor module with software. The proposed controller has an architecture which allows for efficient utilization of logic and DSP (digital signal processing) resources in an FPGA resulting in small implementation complexity.

Terms such as “first”, “second”, and the like, are also used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

It is to be understood that the features of the various embodiments described herein may be combined with each other, unless specifically noted otherwise.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of adaptive gain regulation, comprising:
measuring one or more real-time closed-loop statistics for a signal output from a gain-controllable circuit; and
blindly adjusting the gain of the gain-controllable circuit based on the one or more real-time closed-loop statistics measured for the signal so that the signal output by the gain-controllable circuit satisfies a predetermined criteria without using a priori information about the signal.

2. The method of claim 1, wherein the gain-controllable circuit is an RF analog regulator included in a wireless receiver and the signal is a received signal input to the RF analog regulator.

3. The method of claim 2, wherein the one or more real-time closed-loop statistics is instantaneous power of the received signal as output by the RF analog regulator, and wherein the gain of the RF analog regulator is finely adjusted so that the instantaneous power measured for the received signal satisfies a predetermined power criteria without having a priori information about the received signal.

4. The method of claim 3, further comprising coarsely adjusting the gain of the RF analog regulator if the output of the RF analog regulator is clipped so that no clipping occurs at the output of the RF analog regulator when the gain is finely adjusted.

5. The method of claim 4, comprising selecting the gain of the RF analog regulator during coarse adjustment from a plurality of predetermined gain values.

6. The method of claim 3, comprising determining whether to increase, decrease or maintain the gain of RF analog regulator during fine adjustment based on an average power of the received signal as measured after being output by the RF analog regulator.

7. The method of claim 3, comprising determining the gain of the RF analog regulator during fine adjustment by comparing the instantaneous power of the received signal to the predetermined power criteria using a least-means square analysis.

8. The method of claim 2, further comprising performing digital equalization so that an overall gain of the wireless receiver remains generally constant despite adjustments to the gain of the RF analog regulator.

9. The method of claim 1, wherein the signal is input to a signal processing circuit included in a wireless transmitter, the one or more real-time closed-loop statistics are instantaneous power of the signal input to the signal processing circuit and the instantaneous power of a signal output from the signal processing circuit, and the gain of the gain-controllable circuit is adjusted so that the power of the input and output signals is equalized by comparing the instantaneous powers using a least-means square analysis without using a priori information about the signal.

10. The method of claim 1, wherein the one or more real-time closed-loop statistics is average power or a peak power histogram of the signal, and the gain of the gain-controllable circuit is adjusted so that the average power or the peak power histogram does not exceed a predetermined power threshold by comparing the average power or the peak power histogram and the predetermined power threshold using a least-means square analysis without using a priori information about the signal.

11. An adaptive gain controller, comprising:
a gain-controllable circuit;
an estimator operable to measure one or more real-time statistics for a signal output from the gain-controllable circuit; and
a closed-loop control system operable to blindly adjust the gain of the gain-controllable circuit based on the one or more real-time statistics measured for the signal so that the signal output by the gain-controllable circuit satisfies a predetermined criteria without using a priori information about the signal.

12. The adaptive gain controller of claim 11, wherein the gain-controllable circuit is an RF analog regulator included in a wireless receiver and the signal is a received signal input to the RF analog regulator.

13. The adaptive gain controller of claim 12, wherein the estimator is operable to measure instantaneous power of the received signal as output by the RF analog regulator, and wherein the closed-loop control system is operable to finely adjust the gain of the RF analog regulator so that the instantaneous power measured for the received signal satisfies a predetermined power criteria without having a priori information about the received signal.

14. The adaptive gain controller of claim 13, wherein the closed-loop control system is further operable to coarsely adjust the gain of the RF analog regulator if the output of the RF analog regulator is clipped so that no clipping occurs at the output of the RF analog regulator when the gain is finely adjusted.

15. The adaptive gain controller of claim 14, wherein the closed-loop control system is operable to select the gain of the RF analog regulator during coarse adjustment from a plurality of predetermined gain values.

16. The adaptive gain controller of claim 13, wherein the estimator is operable to measure average power of the received signal after being output by the RF analog regulator, and wherein the closed-loop control system is operable to determine whether to increase, decrease or maintain the gain of RF analog regulator during fine adjustment based on the average power measured by the estimator.

17. The adaptive gain controller of claim 13, wherein the closed-loop control system is operable to determine the gain of the RF analog regulator during fine adjustment by comparing the instantaneous power of the received signal to the predetermined power criteria using a least-means square analysis.

18. The adaptive gain controller of claim 12, wherein the closed-loop control system is further operable to perform digital equalization so that an overall gain of the wireless receiver remains generally constant despite adjustments to the gain of the RF analog regulator.

19. The adaptive gain controller of claim 11, wherein the signal is input to a signal processing circuit included in a wireless transmitter, wherein the estimator is operable to measure instantaneous power of the signal input to the signal processing circuit and the instantaneous power of a signal output from the signal processing circuit, and wherein the closed-loop control system is operable to adjust the gain of the gain-controllable circuit so that the power of the input and output signals is equalized by comparing the instantaneous powers using a least-means square analysis without using a priori information about the signal.

20. The adaptive gain controller of claim 11, wherein the estimator is operable to measure average power or a peak power histogram of the signal, and wherein the closed-loop control system is operable to adjust the gain of the gain-controllable circuit so that the average power or the peak power histogram does not exceed a predetermined power threshold by comparing the average power or the peak power histogram and the predetermined power threshold using a least-means square analysis without using a priori information about the signal.

21. The adaptive gain controller of claim 11, wherein the adaptive gain controller is included in a wireless transceiver, and wherein the closed-loop control system is operable to selectively perform at least one of signal level tracking, transmitter overpower protection, receiver overpower protection, and transmitter gain regulation by comparing the one or more real-time statistics measured for the signal and the predetermined criteria using a least-means square analysis without using a priori information about the signal.
